(19) United States
(12) Patent Application Publication
(10) Pub. No.: US 2004/0024118 A1
(43) Pub. Date: Feb. 5, 2004

(54) Process for the preparation of urethane (meth) acrylates

(75) Inventors: Thomas Weihrauch, Duelmen (DE); Andreas Wenning, Nottuln (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/367,887

(22) Filed: Feb. 19, 2003

(30) Foreign Application Priority Data
Oct. 29, 2002 (DE) 102 50 512.8
Feb. 16, 2002 (DE) 102 06 483.0

(51) Int. Cl. C08G 18/00

(52) U.S. Cl. 525/54.3; 525/418; 525/452

(57) ABSTRACT

The invention relates to a process for the solvent-free, continuous preparation of urethane (meth)acrylates in an extruder, intensive kneader, intensive mixer or static mixer. These urethane acrylates can be used for the preparation of radiation-curable transparent or pigmented coating compositions, in particular powder coating compositions.

The invention relates to a process for the solvent-free, continuous preparation of urethane (meth)acrylates in an extruder, intensive kneader, intensive mixer or static mixer. These urethane acrylates can be used for the preparation of radiation-curable transparent or pigmented coating compositions, in particular powder coating compositions.

Radiation-curable coating compositions have long been part of the prior art. Powder coating compositions which are crosslinked by radiation have only recently become known and are increasingly being used in the coatings-processing industry. Their advantages are the very short crosslinking time of a few seconds and optimum leveling of the coating through separation of the melting process from the radiation crosslinking. In addition, substrates such as wood or wood-based materials, plastics, glass, paper or metallic substrates with mounted temperature-sensitive components can also be coated.

Urethane (meth)acrylates as binders for radiation-curable powder coating compositions are described, for example, in DE 199 44 156, DE 199 47 521, EP 1 103 572, U.S. Pat. No. 3,974,303 or DE 100 58 617 and are prepared exclusively by a batch process in a solvent or in the absence of a solvent.

The preparation of urethane (meth)acrylates in a solvent not only has the disadvantage that the solvent or the solvent mixture has to be removed again subsequently. Complicated, special technologies for solvent removal are also required. Thin-film apparatuses or filmtruders are suitable, for example, for freeing the reaction products susceptible to polymerization at elevated temperature from the solvent under reduced pressure at relatively low temperatures of less than 130° C. However, these processes are very expensive.

The possibility of preparing urethane (meth)acrylates in a solvent-free batch process is limited. In particular, amorphous urethane (meth)acrylates having a high glass transition temperature cannot be prepared in such a process. The reaction temperature would have to be chosen so high that the polymerization of the products of the process can no longer be reliably avoided.

It was therefore an object of the present invention to provide a novel process for the preparation of urethane (meth)acrylates which does not have the stated disadvantages of the prior art.

Surprisingly, it has been found that urethane (meth)acrylates can be prepared rapidly and with little complication in an extruder, intensive kneader, intensive mixer or static mixer without a (partial) polymerization of the (meth)acrylate double bonds occurring.

The invention therefore relates to a process for the solvent-free and continuous preparation of urethane (meth)acrylates having a melting range of from 30 to 130° C. by reacting

A) at least one polymer containing hydroxyl groups,

B) at least one di- or polyisocyanate,

C) at least one polymerizable compound having at least one free hydroxyl group and a polymerizable (meth)acrylate group

in an extruder, intensive kneader, intensive mixer or static mixer by thorough mixing and brief reaction with heat supply and subsequent isolation of the end product by rapid cooling.

The principle of the process consists in the fact that the reactants are reacted continuously in an extruder, intensive kneader, intensive mixer or static mixer by thorough mixing and brief reaction with heat supply. If desired, a continuous subsequent reaction is effected. By subsequent rapid cooling, it is then possible to obtain the end product.

In general, temperatures of from 10 to 325° C. are used in the process, the temperature being varied according to the product, as shown in the examples. This means that the residence time of the starting materials in the abovementioned units is usually from 3 seconds to 15 minutes, preferably from 3 seconds to 5 minutes, particularly preferably from 5 to 180 seconds. The reactants are reacted briefly with heat supply at temperatures of from 25° C. to 320° C., preferably from 50 to 250° C., very particularly preferably from 70 to 220° C.

Units which are particularly suitable and preferably used for the process according to the invention are extruders, such as single-screw or multiscrew extruders, in particular twin-screw extruders, planetary extruders or ring extruders, intensive kneaders, intensive mixers, such as Thorax mixers, or static mixers.

It was surprising that the reaction which requires several hours in the batch process takes place completely in a few seconds in said units. According to the prior art, it is not possible to obtain simply processible amorphous products having a high glass transition temperature required for a good shelf life. The reaction product has a very high viscosity. Consequently, it can be mechanically transferred from the reactor only with difficulty. Moreover, high temperatures are required for reaction of starting materials and stirrability of the melt. Particularly in the case of industrially relevant production quantities, an at least partial polymerization of the unsaturated acrylate groups takes place. As a result, the product can no longer be used. It has to be removed mechanically from the vessel with considerable effort. A basic fact is that brief thermal loading in association with the mixing effect of the intensive kneader is sufficient to react the reactants completely or very substantially. Through suitable equipping of the mixing chambers or combination of the screw geometries, the intensive kneaders permit rapid thorough mixing with simultaneous intensive heat exchange. On the other hand, uniform flow in the longitudinal direction with as standard a residence time as possible is also ensured. Moreover, different thermostating in the individual apparatus barrels or sections must be possible.

The reaction products are metered to the units as a rule in separate product streams. In the case of more than two product streams, these can also be fed in in combination. Amorphous and/or crystalline polymers containing hydroxyl groups can be combined to form one product stream. It is also possible additionally to introduce catalysts and/or additives, such as leveling agents, stabilizers or adhesion promoters, into this product stream. Mono- or polyisocyanate can also be reacted with a polymerizable compound having at least one free alcohol group and a polymerizable (meth)acrylate group and can be combined with catalysts and/or additives, such as leveling agents, stabilizers or adhesion promoters, to form one product stream. The material streams can also be divided and thus fed to the unit in different proportions at various points. In this way, concentration gradients can be established in a controlled manner, which can bring about completeness of the reaction. The entries of the product streams in the sequence can be varied and staggered in time.

For the preliminary reaction and/or completion of the reaction, a plurality of units can also be combined.

The cooling following the rapid reaction can be integrated in the reaction part, in the form of a multi-barrel embodiment, as in the case of extruders or Conterna machines. The following may also be used: tube bundles, pipe coils, chill rolls, air conveyors and conveyor belts of metal.

Depending on the viscosity of the product leaving the intensive kneader zone or the postreaction zone, the compounding is initially brought to a suitable temperature by further cooling by means of appropriate abovementioned apparatuses. Pelleting or comminution is then effected to a desired particle size by means of a roll crusher, a pinned-disk mill, a hammer mill, scale rolls or the like.

Urethane (meth)acrylates in the context of this invention consist of a polymer A) which contains hydroxyl groups and to which urethane groups and acrylate groups are bonded by reaction with di- or polyisocyanates B) and acrylate-containing alcohols C).

The polymer A) containing hydroxyl groups may be a polymer, a polycondensate or a polyaddition compound. Preferred components are polyesters, polyethers, polyacrylate, polythioethers, polyacetals, polyesteramides, epoxy resins having hydroxyl groups in the molecule, aminoplasts and their modification products with polyfunctional alcohols, polyazomethines, polyurethanes, polysulfonamides, melamine derivatives, cellulose esters, cellulose ethers and partially hydrolyzed homo- or copolymers of vinyl esters.

Polyesters and polyacrylates are particularly preferred.

The urethane (meth)acrylates according to the invention may be amorphous or (semi)crystalline. Mixtures of amorphous and (semi)crystalline urethane (meth)acrylates can also be used.

If amorphous polyesters having a Tg of 35-80° C. are used as polymers A) containing hydroxyl groups, they are reacted with di- or polyisocyanates B) and a compound C) which simultaneously contains at least one hydroxyl group and at least one polymerizable acrylate group to give the amorphous urethane (meth)acrylates according to the invention. These urethane (meth)acrylates likewise have urethane groups, such as terminal (meth)acrylate groups.

The amorphous polyesters containing hydroxyl groups and having a Tg of 35-80° C. are prepared by polycondensation of suitable dicarboxylic acids and diols. The condensation is effected in a manner known per se in an inert gas atmosphere at temperatures of from 100 to 260° C., preferably from 130 to 220° C., in the melt or by an azeotropic procedure are obtained [sic], as described, for example, in Methoden der Organischen Chemie [Methods of Organic Chemistry] (Houben-Weyl); Volume 14/2, pages 1 to 5, 21 to 23, 40 to 44, Georg Thieme Verlag, Stuttgart, 1963, or in C. R. Martens, Alkyd Resins, pages 51 to 59, Reinhold Plastics Appl. Series; Reinhold Publishing Comp., New York, 1961. The carboxylic acids preferred for the preparation of polyesters may be aliphatic, cycloaliphatic, aromatic and/or heterocyclic and may be optionally substituted by halogen atoms and/or unsaturated. The following may be mentioned as examples of these: succinic, adipic, suberic, azelaic, sebacic, phthalic, terephthalic, isophthalic, trimellitic, pyromellitic, tetrahydrophthalic, hexahydrophthalic, hexahydroterephthalic, di- and tetrachlorophthalic, endomethylenetetrahydrophthalic and glutaric acid, 1,4-cylcohexanedicarboxylic acid and—where obtainable—their anhydrides or esters. Isophthalic acid, terephthalic acid, hexahydroterephthalic acid and 1,4-cyclohexanedicarboxylic acid are particularly suitable.

Suitable polyols are, for example, monoethylene glycol, 1,2- and 1,3-propylene glycol, 1,4- and 2,3-butylene glycol, di-β-hydroxyethylbutanediol, 1,5-pentanediol, 1,6-hexanediol, 1,8-octanediol, decanediol, dodecanediol, neopentylglycol, cyclohexanediol, 3(4),8(9)-bis(hydroxymethyl)tricyclo[5.2.10^{2,6}]decane (dicidol), bis(1,4-hydroxymethyl)cyclohexane, 2,2-bis(4-hydroxycyclohexyl)propane, 2,2-bis[4-(β-hydroxyethoxy)phenyl]propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol and sorbitol and diethylene glycol, triethylene glycol, tetraethylene glycol, dipropylene glycol, polypropylene glycols, polybutylene glycols, xylylene glycol and neopentylglycol hydroxypivalate. Monoethylene glycol, neopentylglycol, dicidol, cyclohexanedimethanol, trimethylolpropane and glycerol are preferred.

A subsequent or additional reaction of the polyesters with polyisocyanates is possible. In such cases, isophorone diisocyanate isocyanurate [sic], for example, can advantageously be used.

Amorphous polyesters prepared in this manner have an OH number of 15-100 mg KOH/g, a Tg of 35-80° C. and an acid number of <5. Mixtures of amorphous polyesters may also be used.

If crystalline polyesters are used as polymers A) containing hydroxyl groups, they are reacted with di- or polyisocyanates B) and a compound C) which simultaneously contains at least one hydroxyl group and at least one polymerizable acrylate group to give the crystalline urethane (meth)acrylates according to the invention. These urethane (meth)acrylates likewise have urethane groups, such as terminal (meth)acrylate groups.

Crystalline polyesters containing hydroxyl groups are prepared by polycondensation as already described for amorphous polyesters. For this purpose, an acid component, consisting of a saturated linear aliphatic or cycloaliphatic dicarboxylic acid having 4-14 carbon atoms or another aliphatic or cycloaliphatic or aromatic di- or polycarboxylic acid, is reacted with an alcohol component, consisting of a linear aliphatic diol having 2-15 carbon atoms and another aliphatic or cycloaliphatic di- or polyol having 2-15 carbon atoms. The crystalline polyesters containing hydroxyl groups and prepared in this manner have an OH number of 15-80 mg KOH/g, an acid number of <5 mg KOH/g and a melting point of 40-130° C.

Carboxylic acids preferred for the preparation of crystalline polyesters are succinic acid, adipic acid, suberic acid, azelaic acid, sebacic acid, dodecanedioic acid, 1,4-cyclohexanedicarboxylic acid, phthalic acid, terephthalic acid, isophthalic acid, trimellitic acid, pyromellitic acid, tetrahydrophthalic acid, hexahydrophthalic acid, hexahydroterephthalic acid, endomethylenetetrahydrophthalic acid, glutaric acid and—where obtainable—their anhydrides or esters. Dodecanedioic acid, adipic acid, succinic acid, sebacic acid, isophthalic acid, terephthalic acid, hexahydroterephthalic acid and 1,4-cyclohexanedicarboxylic acid are particularly suitable.

Suitable polyols are, for example, monoethylene glycol, 1,2- and 1,3-propylene glycol, 1,4- and 2,3-butylene glycol, di-β-hydroxyethylbutanediol, 1,5-petanediol, 1,6-hexanediol, 1,8-octanediol, decanediol, dodecanediol, neopentylglycol, cyclohexanediol, 3(4),8(9)-bis(hydroxymethyl)tricyclo[5.2.1.0^{2,6}]decane (dicidol), bis(1,4-hydroxymethyl)cyclohexane, 2,2-bis(4-hydroxycyclohexyl)propane, 2,2-bis[4-(β-hydroxyethoxy)phenyl]propane, 2-methyl-1,3-propanediol, 2-methyl-1,5-pentanediol, 2,2,4(2,4,4)-trimethyl-1,6-hexanediol, glycerol, trimethylolpropane, trimethylolethane, 1,2,6-hexanetriol, 1,2,4-butanetriol, tris(β-hydroxyethyl) isocyanurate, pentaerythritol, mannitol and sorbitol and diethylene glycol, triethylene glycol, tetraethylene glycol, dipropylene glycol, polypropylene glycols, polybutylene glycols, xylylene glycol and neopentylglycol hydroxypivalate. Monoethylene glycol, butanediol, hexanediol, neopentylglycol, cyclohexanedimethanol, trimethylolpropane and glycerol are preferred.

In the urethane (meth)acrylates according to the invention, diisocyanates having an aliphatic, (cyclo)aliphatic or cycloaliphatic structure are used as polyisocyanates B). Representative examples of the polyisocyanates are 2-methylpentamethylene 1,5-diisocyanate, hexamethylene diisocyanate, trimethylhexamethylene 1,6-diisocyanate, in particular the 2,2,4- and the 2,4,4-isomers and industrial mixtures of the two isomers, 4,4′-methylenebis(cyclohexyl) isocyanate), norbornane diisocyanate and 3,3,5-trimethyl-1-isocyanato-3-isocyanatomethylcyclohexane (IPDI). Also suitable are polyisocyanates which are obtainable by reacting polyisocyanates with themselves via isocyanate groups, such as isocyanurates, which form through reaction of three isocyanate groups. The polyisocyanates may also contain biuret or allophanate groups. IPDI is particularly suitable.

Suitable polymerizable compounds C) having at least one free hydroxyl group and a polymerizable (meth)acrylate group are, for example, hydroxyethyl acrylate (HEA), hydroxyethyl methacrylate (HEMA), hydroxypropyl acrylate, hydroxypropyl methacrylate, glyceryl diacrylate and glyceryl dimethacrylate. Hydroxyethyl acrylate (HEA) is particularly suitable.

If amorphous or crystalline urethane (meth)acrylates are to be prepared together, any desired mixing ratio of the amorphous and crystalline starting polyesters can be established.

The reaction between the polymers containing hydroxyl groups, the mono- or polyisocyanates and the polymerizable compounds having at least one free hydroxyl group and a polymerizable (meth)acrylate group can be accelerated by catalysts, such as, for example, tin compounds. A suitable catalyst is, for example, dibutyltin dilaurate (DBTL). The concentration of the catalysts is from 0.01 to 5% by weight, preferably from 0.01 to 3% by weight, based on the total formulation.

The urethane (meth)acrylates prepared according to the invention are suitable as binders for radiation-curable coating compositions, in particular for powder coating compositions.

For the preparation of the radiation-curable powder coating compositions, the urethane (meth)acrylates prepared according to the invention are formulated with additives and auxiliaries and, if required, pigments and/or fillers, which are known to a person skilled in the art. All starting materials are mixed with one another. The homogenization or dispersing of the starting materials can be effected in suitable units, such as, for example, heatable kneaders, but preferably by extrusion.

The radiation-curable powder coating compositions thus prepared can be applied by the conventional powder coating methods, such as, for example, electrostatic or tribostatic powder spraying, fluidized-bed coating or electrostatic fluidized-bed coating. Suitable substrates are, for example, untreated or pretreated metallic substrates, wood, wood-based materials, plastics, glass or paper.

The subject of the invention is explained below with reference to examples.

### EXAMPLES

Preparation of the urethane (meth)acrylates by the process according to the invention

1. Amorphous urethane acrylate

Starting Materials;

3 770 g of the amorphous polyester of isophthalic acid 100%, monoethylene glycol 20% and dicidol 80%, containing hydroxyl groups (OH number 40 mg KOH/g, Tg 75° C.), 750 g of IPDI, 10 g of IONOL CP, 10 g of DBTL and 470 g of hydroxyethyl acrylate.

The following three material streams were employed:

Stream 1 consisted of a mixture of isophorone diisocyanate (IPDI) and DBTL.

Stream 2 consisted of a solution of IONOL CP in hydroxyethyl acrylate.

Stream 3 consisted of a melt of the amorphous polyester of isophthalic acid (100%), monethylene glycol (20%) and dicidol (80%), containing hydroxyl groups.

Stream 1 was fed at a rate of 380 g/h into the first barrel of a twin-screw extruder (temperature of the material stream from 25 to 50° C.).

Stream 2 was fed into the same barrel at a rate of 240 g/h (temperature of the material stream from 25 to 40° C.).

Stream 3 was fed into the third barrel at a rate of 1 885 g/h (temperature of the material stream about 190° C.).

The extruder used consisted of 8 barrels which could be separately heated and cooled. Barrel 1: 70-100° C., barrel 2: 70-150° C., barrels 3-8: 160-220° C.

All temperatures were setpoint temperatures. Regulation was effected by means of electrical heating or water cooling. The die was likewise electrically heated. The screw speed was from 25 to 100 rpm. The throughput in this example was 2 505 g/h.

The reaction product was then cooled and crushed or milled. It had a content of 0.15% of free NCO groups and a Tg of 62° C.

2. Crystalline urethane acrylate

Starting Materials:

3 986 g of the crystalline polyester of dodecanedioic acid 100% and monoethylene glycol 100%, containing hydroxyl groups (OH number 31 mg KOH/g, m.p. 81° C.), reaction product of the reaction of 618 g of IPDI and 388 g of hydroxyethyl acrylate, 3.8 g of IONOL CP and 3.8 g of DBTL.

The following two material streams were employed:

Stream 1 consisted of a solution of IONOL CP and of DBTL in the reaction product of IPDI and hydroxyethyl acrylate.

Stream 2 consisted of a melt of the crystalline polyester of dodecanedioic acid (100%) and monoethylene glycol (100%), containing hydroxyl groups.

Stream 1 was fed at a rate of 507 g/h into the first barrel of a twin-screw extruder (temperature of the material stream from 25 to 50° C.).

Stream 2 was fed into the second barrel at a rate of 1 993 g/h (temperature of the material stream 150-190° C.).

The extruder used consisted of 8 barrels which could be separately heated and cooled. Barrel 1: 20-50° C., barrel 2: 150-200° C., barrels 3-8: 160-220° C.

All temperatures were setpoint temperatures. Regulation was effected by means of electrical heating or water cooling. The die was likewise electrically heated. The screw speed was from 25 to 100 rpm. The throughput in this example was 2 500 g/h.

The reaction product was cooled and crushed or milled. It had a content of <0.1% of free NCO groups and a melting point of 80° C.

3. Mixture of amorphous and crystalline urethane acrylate

Starting Materials:

80% by weight of amorphous polyester from 1), 20% by weight of crystalline polyester from 2), otherwise as above.

The specific formulation is as follows:

3 010 g of the amorphous polyester of isophthalic acid 100%, monoethylene glycol 20% and dicidol 80%, containing hydroxyl groups (OH number 40 mg KOH/g, Tg 75° C.), 797 g of the crystalline polyester of dodecanedioic acid 100% and monoethylene glycol 100%, containing hydroxyl groups (OH number 31 mg KOH/g, m.p. 81° C.), reaction product from the reaction of 723 g of IPDI with 453 g of hydroxyethyl acrylate, 9 g of IONOL CP and 9 g of DBTL.

The following two material streams were employed:

Stream 1 consisted of a solution of IONOL CP and of DBTL in the reaction product of IPDI and hydroxyethyl acrylate.

Stream 2 consisted of a melt of a mixture of 80% by weight of the amorphous polyester of isophthalic acid 100%, monoethylene glycol 20% and dicidol 80%, containing hydroxyl groups, and 20% by weight of the crystalline polyester of dodecanedioic acid 100% and monoethylene glycol 100%, containing hydroxyl groups.

Stream 1 was fed at a rate of 597 g/h into the first barrel of a twin-screw extruder (temperature of the material stream from 25 to 50° C.).

Stream 2 was fed into the second barrel at a rate of 1 903 g/h (temperature of the material stream 150-190° C.).

The extruder used consisted of 8 barrels which could be separately heated and cooled. Barrel 1: 20-50° C., barrel 2: 150-200° C., barrels 3-8: 160-220° C.

All temperatures were setpoint temperatures. Regulation was effected by means of electrical heating or water cooling. The die was likewise electrically heated. The screw speed was from 25 to 100 rpm. The throughput in this example was 2 500 g/h.

The reaction product was cooled and crushed or milled. It had a content of 0.12% of free NCO groups.

1. A process for the solvent-free, continuous preparation of a urethane (meth)acrylate having a melting range of from 30 to 130° C. by reacting
A) at least one polymer containing hydroxyl groups,
B) at least one di- or polyisocyanate,
C) at least one polymerizable compound having at least one free hydroxyl group and a polymerizable (meth)acrylate group
in an extruder, intensive kneader, intensive mixer or static mixer by thorough mixing and brief reaction with heat supply and subsequent isolation of the end product by rapid cooling.

2. A process according to claim 1, characterized in that the polymer A) containing hydroxyl groups is a polyester, polyacrylate, polythioether, polyacetal, polyesteramide, epoxy resin having hydroxyl groups in the molecule, aminoplast, aminoplasts modified by a polyfunctional alcohol, polyazomethine, polyurethane, polysulfonamide, melamine derivative, cellulose ester, cellulose ether or partially hydrolyzed homo- or copolymer of a vinyl ester.

3. A process according to claim 2, characterized in that the polyester A) containing hydroxyl groups is amorphous.

4. A process according to claim 2, characterized in that the polyester A) containing hydroxyl groups is crystalline.

5. A process according to claim 2, characterized in that the polyester A) containing hydroxyl groups is a mixture of amorphous and crystalline polyesters.

6. A process according to at least one of claims 1 to 5, characterized in that isophorone diisocyanate, hexamethylene diisocyanate, trimethylhexamethylene diisocyanate, dicyclohexylmethyl diisocyanate or 2,2,6-trimethyl-1,4-diisocyanatocyclohexane, norbornane diisocyanate, alone or in mixtures or secondary products of these diisocyanates, such as isocyanurates, allophanates or biurets, are used as di- or polyisocynate B).

7. A process according to any one of claims 1 to 6, characterized in that hydroxyethyl acrylate is used as polymerizable compound C) having at least one free hydroxyl group and a polymerizable (meth)acrylate group.

8. A process according to any one of claims 1 to 7, characterized in that the reaction is carried out in a single-screw, twin-screw or multiscrew extruder, ring extruder or planetary extruder.

9. A process according to claim 8, characterized in that the reaction is carried out in a twin-screw extruder.

10. A process according to any one of claims 1 to 7, characterized in that the reaction is carried out in an intensive mixer or intensive kneader.

11. A process according to any one of claims 1 to 7, characterized in that the reaction is carried out in a static mixer.

12. A process according to any one of claims 1 to 11, characterized in that the reaction is carried out in an extruder, intensive kneader, intensive mixer or static mixer having a plurality of identical or different barrels or housings which can be thermally controlled independently of one another.

13. A process according to any one of claims 1 to 12, characterized in that the temperature in the extruder, intensive kneader, intensive mixer or static mixer is from 10 to 325° C.

14. A process according to any one of claims 1 to 13, characterized in that, by suitable equipping of the mixing chambers and combination of the screw geometries, the extruder or intensive kneader on the one hand lead [sic] to rapid thorough mixing and rapid reaction with simultaneous intensive heat exchange and, on the other hand, effect [sic] a uniform flow in the longitudinal direction with as standard a residence time as possible.

15. A process according to any one of claims 1 to 14, characterized in that the reaction is carried out in the presence of catalysts and/or additives.

16. A process according to any one of claims 1 to 15, characterized in that the starting materials and/or catalyst and/or additives are fed together or in separate product streams, in liquid or solid form, to the extruder, intensive kneader, intensive mixer or static mixer.

17. A process according to claim 16, characterized in that the additives are combined with the starting materials to give one product stream.

18. A process according to any one of claims 1 to 17, characterized in that the di- or polyisocyanate B) are [sic] reacted with the polymerizable compound C) having at least one free alcohol group and a polymerizable (meth)acrylate group before they are fed in one product stream to the extruder, intensive kneader, intensive mixer or static mixer.

19. A process according to any one of claims 1 to 18, characterized in that, in the case of more than two product streams, these are fed in in combination.

20. A process according to any one of claims 1 to 19, characterized in that one or both product streams are divided.

21. A process according to any one of claims 1 to 20, characterized in that the catalyst is combined with one of the material streams or is present in solution in one of the streams.

22. A process according to any one of claims 1 to 21, characterized in that the additive is combined with one of the material streams or is present in solution in one of the streams.

23. A process according to any one of claims 1 to 22, characterized in that the entries of the product streams are variable in sequence and staggered in time.

24. A process according to any one of claims 1 to 23, characterized in that a subsequent reaction is added.

25. A process according to claim 24, characterized in that the subsequent reaction is carried out in continuously operated systems, such as tube reactors, stirred or unstirred dwell tanks or tube bundles.

26. A process according to any one of claims 1 to 25, characterized in that, depending on the viscosity of the product leaving the extruder, intensive kneader, intensive mixer or static mixer and/or the postreaction zone, the compounding first is initiated by further cooling to a temperature sufficient for the subsequent filling/storage.

27. A process according to at least one of claims 1 to 26, characterized in that the residence time of the starting materials is from 3 seconds to 15 minutes, preferably from 3 seconds to 5 minutes, particularly preferably from 5 to 180 seconds.

28. A process according to at least one of claims 1 to 27, characterized in that the reaction is carried out at temperatures of from 25 to 320° C., preferably from 50 to 250° C., particularly preferably from 70 to 220° C.

29. The use of the urethane (meth)acrylates prepared according to any of claims 1 to 28 as binders for the preparation of radiation-curable solvent-containing coating compositions or powder coating compositions.
